(19) United States
(12) Patent Application Publication
(10) Pub. No.: US 2004/0232596 A1
(43) Pub. Date: Nov. 25, 2004

(54) Method of operating a rotary tabletting machine and a rotary tabletting machine

(76) Inventors: Jurgen Hinzpeter, Schwarzenbek (DE); Werner Seifert, Wentorf (DE); Ulrich Zeuschner, Schwarzenbek (DE); Jan Naeve, Schattin (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/829,530

(22) Filed: Apr. 22, 2004

(30) Foreign Application Priority Data
Apr. 23, 2003 (DE) 103 18 529.1

(51) Int. Cl. B29C 43/08

(52) U.S. Cl. 264/297.1; 425/347

(57) ABSTRACT

A method for operating a rotary tabletting machine the rotor of which has a die-plate, upper rams, and lower rams which interact with the die bores, and has a stationary filling device interacting with the upper side of said die-plate, and wherein the lower rams are located in the die bores when they run along beneath the filling device and said lower rams are adjusted in their positions by means of a filling and/or proportioning cam, wherein said filling and/or proportioning cams is set into vibrations.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

As is known rotary tabletting machines have a rotor which has a die-plate, and seats or guides for upper and lower rams which interact with the bores of the die plate. The lower and upper rams are guided by means of appropriate cam segments and pressure-applying rollers interact with the rams in the area of the pressure-applying stations to compress the material filled into the die bores. The die bore is filled by a stationary filling device, e.g. a feed shoe, beneath which the die bores are moved along. While filling is under way the lower rams are in the die bore with their position predetermining the charge. While entering the feed shoe, the lower rams are gradually moved down with a proportioning procedure taking place at the end of the filling operation. In the predetermined filling position, the lower ram is slightly displaced beyond the desired position so that some excessive filling is accomplished. Such excessive filling is eliminated again subsequently as the lower ram is elevated with a stripper wiping off the powder exiting towards the upper side of the die-plate.

An important parameter for the quality of the tablets is the compressive force which is needed during the compression of the powder to be pressed together. The compressive force is influenced, inter alia, by the length of the pair of rams, the impact of the pressure-applying rollers, and the mass of the material to be compacted. The mass, in turn, depends on the diameter of the die bore, the length of the lower ram, and specifically, on a uniform and homogeneous filling of the die.

It has been found that the rotation of the rotor also has an influence as the centrifugal force causes the material to be spread irregularly within the die bore. Bridge and cavity formation might occur.

It is the object of the invention to reduce the formation of bridges and cavities in the die bores during the operation a rotary tabletting machine.

### BRIEF SUMMARY OF THE INVENTION

In the inventive method, the filling and/or proportioning cam is set into vibrations. It is preferred that the main direction of vibration be vertical, i.e. in the direction of the axes of the lower rams.

The vibrations can be are produce electrically, mechanically, pneumatically, hydraulically or in combination. The amplitude and even the frequency can be varied freely and will be chosen preferably in dependence on the number of revolutions of the rotor.

Because of the vibrations of the filling and/or proportioning cam, the lower ram will also undergo vibrations which are transferred to the filling material. Therefore, the filling material is subjected to the vibrations during the filling procedure, which cause it to be distributed more homogeneuously within the die bore. This also helps obtain a more uniform compaction of the filling material, which causes the tablets to exhibit a constant disintegration speed and to release their active substances more evenly at a later time.

The control cam for the lower rams in the area of the feed shoe is usually composed of two portions, namely the filling cam portion in front of the feed shoe and that in the area of the feed shoe at the beginning of the movement of the die bore. At this point, the lower rams are successively moved downwards up to a predetermined lower end position. During this movement of the compression ram, the powder is filled into the gradually increasing space above the lower ram, via the feed shoe. The compression rams are moved upwards to a minimum degree in the proportioning cam portion with the position reached thereby determining the desired charge volume in the die bore. The powder which is squeezed out is stripped off by means of a stripper. The lower rams will be slightly lowered again after this operation to prevent material from being urged sidewards while the upper ram is being introduced. According to the invention, both of the cam portions, which can be formed by separate cam segments, are set into vibrations. The vibration generator required either acts upon the two cam portions together or each cam portion has associated therewith a separate vibration generator.

An embodiment of the invention will be described in more detail below with reference to a drawing.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

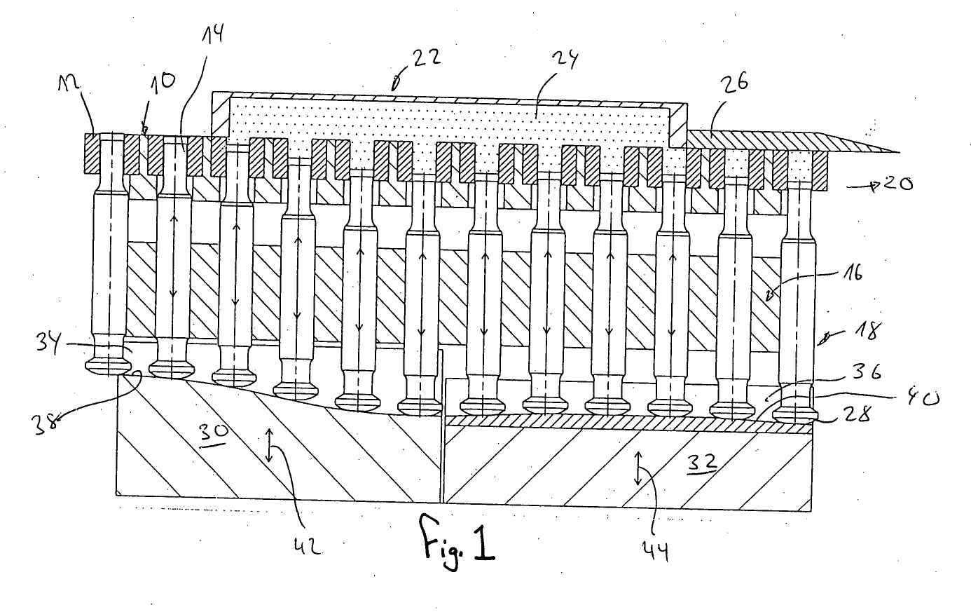

FIG. 1 shows a section through the rotor of a rotary tabletting machine in the area of a feed shoe.

In FIG. 1, a die-plate 10 is shown which is arranged on a circle and has a series of dies 12 with die bores 14. Below the die-plate 10, there is a guide disc 16 which rotates in synchronism with the die-plate 10 and guides lower rams 18 inside guide bores. In operation, the die-plate 10 moves in the direction of the arrow 20. The die-plate has stationarily arranged thereabove a feed shoe 22 which has been filled with powder 24 (the supply of powder to the feed shoe not being shown). A stripper plate 26 is disposed at the right-hand end of the feed shoe 22.

As can be understood from the figure the lower ends 28 of the lower rams 18 interact with cam segments 30 and 32. The cam segments each have a groove 34 and 36 open to the top the bottom of which forms a control cam 38 and 40 each. The control cam 38 is the filling cam which provides for the lower rams 18 to be gradually moved to the bottom while releasing a charge volume in the die bore 14. The end position is reached at the right-hand end of the filling cam 38. The end position will not determine yet the final charge volume or the quantity of the powder 24 that is to be filled into the die bore 14.

The cam 40 is a proportioning cam. It has a gently ascending portion which joins the portion of the filling cam 38, and a gently descending portion in the right-hand end region. The maximum elevated position of the lower rams 18, approximately in the middle of the proportioning cam 40 determines the desired position of the lower ram and the final charge volume from which some part of the powder filled in before is moved out again. This part is stripped off by the stripper plate 26.

A vibration generator which is not shown and operates on a mechanical, hydraulic, electric, pneumatic basis or the like is associated with the segments 30, 32 to set them into vertical vibrations as outlined by the arrows 44. It is understood that each segment 30, 32 may have associated therewith a vibration generator of its own. The frequency and amplitude of vibration for the segments 30, 32 can be chosen freely and is preferably dependent on the speed of rotation of the die-plate 10.

The vibration of the segments 30, 32 is transferred to the lower rams 18 the vibration of which, in turn, acts upon the material which was filled in, and homogenizes it in the area of the die bore 24.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for operating a rotary tabletting machine the rotor of which has a die-plate, upper rams, and lower rams which interact with the die bores, and has a stationary filling device interacting with the upper side of said die-plate, and wherein the lower rams are located in the die bores when they run along beneath the filling device and said lower rams are set in their positions by means of a filling and/or proportioning cam, characterized in that said filling and/or proportioning cam is set into vibrations.

2. The method according to claim 1, characterized in that said filling and/or proportioning cam is set into vertical vibrations.

3. The method according to claim 1, characterized in that said vibrations are produced by an electric, mechanical, pneumatic or hydraulic vibration generator.

4. The method according to claim 3, characterized in that the amplitude and/or frequency of the vibration is variable.

5. The method according to claim 4, characterized in that the frequency and/or amplitude is dependent on the number of revolutions of the rotor.

6. A rotary tabletting machine including a rotor which has a die-plate with the die bores and upper and lower rams which interact with said die bores, a stationary filling device interacting with the upper side of said die-plate, and at least one cam member for the lower rams below the filling device which predetermines the position of said lower rams in said die bores in the area of the feed shoe, characterized in that the cam member (30, 32) has associated therewith a vibration generator.

7. The rotary tabletting machine according to claim 6, characterized in that a filling cam member (30) and a proportioning cam member (32) are provided and said vibration generator acts upon both of the cam members or each cam member has associated therewith a vibration generator.
